(19) United States
(12) Patent Application Publication
(10) Pub. No.: US 2024/0370981 A1
(43) Pub. Date: Nov. 7, 2024

(54) Image Processing Method, Computing System, Device and Readable Storage Medium

(71) Applicant: BOE Technology Group Co., Ltd., Beijing (CN)

(72) Inventors: Dan Zhu, Beijing (CN); Guannan Chen, Beijing (CN); Yanhong Wu, Beijing (CN)

(73) Assignee: BOE Technology Group Co., Ltd., Beijing (CN)

(21) Appl. No.: 18/030,429

(22) PCT Filed: Mar. 24, 2022
(86) PCT No.: PCT/CN2022/082807

§ 371 Date: Apr. 5, 2023

(51) Int. Cl. G06T 5/92; G06T 3/4053; G06V 10/771

(52) U.S. Cl. CPC G06T 5/92; G06T 3/4053; G06V 10/771; G06T 2207/20084; G06T 2207/20208

(57) ABSTRACT

The present disclosure provides an image processing method, a computing system, a device, and a readable storage medium. The image processing method includes: using an inverse tone mapping neural network to process a first image, the inverse tone mapping neural network is configured to expand a dynamic range of the first image and a color gamut range of the first image to obtain a second image that is expanded, the inverse tone mapping neural network includes a mapping network, the mapping network is used to realize the expansion, and the inverse tone mapping neural network further includes an attention network, an input of the mapping network and an input of the attention network are both the first image, the attention network is used to process image contents of the first image to generate correction coefficients, and the correction coefficients are used to correct parameters of the mapping network.

### TECHNICAL FIELD

The present disclosure relates to a technical field of image processing, and more particularly, to an image processing method, a computing system, a device and a readable storage medium.

### BACKGROUND

Artificial intelligence technology is widely used in the field of image processing. Image processing generally includes modification and color adjustment for image, image beautification, image denoising, image super-resolution conversion, image enhancement and other processing tasks. For example, neural network is used to realize the conversion from an original Standard Dynamic Range (SDR) image to a High Dynamic Range (HDR) image, noise reduction, super-resolution conversion, etc. Compared with the original image, the processed image can better display visual information in real scenes.

### SUMMARY

Some embodiments of the present disclosure provide an image processing method, a computing system, a device, and a readable storage medium for improving image processing effects.

According to an aspect of the present disclosure, an image processing method is provided. The method includes: using an inverse tone mapping neural network to process a first image, in which the inverse tone mapping neural network is configured to expand a dynamic range of the first image and a color gamut range of the first image to obtain a second image that is expanded, the inverse tone mapping neural network includes a mapping network, the mapping network is used to realize the expansion, and the inverse tone mapping neural network further includes an attention network, an input of the mapping network and an input of the attention network are both the first image, the attention network is used to process image contents of the first image to generate correction coefficients, and the correction coefficients are used to correct parameters of the mapping network.

According to some embodiments of the present disclosure, the mapping network includes a first convolution network, a self-residual network and a second convolution network, the mapping network being used to realize the expansion, includes: using the first convolution network to process the first image, to obtain a first feature map; using the self-residual network to process the first feature map, to obtain a second feature map; and using the second convolution network to process the second feature map, to obtain a third feature map, in which the third feature map is used as the second image, the correction coefficients are used to correct parameters of the self-residual network.

According to some embodiments of the present disclosure, the self-residual network includes m self-residual modules that are connected in sequence, m is an integer greater than 1, using the self-residual network to process the first feature map, includes: using a first processing path and a second processing path of a first self-residual module in the self-residual network to separately process the first feature map that is received to obtain a first residual feature map; using a first processing path and a second processing path of an i-th self-residual module in the self-residual network to separately process an (i-1)-th residual feature map that is obtained by an (i-1)-th self-residual module to obtain an i-th residual feature map, i is an integer greater than 1 and less than or equal to m, the first processing path includes a residual convolution layer, and the second processing path is used to skip processing of the residual convolution layer.

According to some embodiments of the present disclosure, a number of feature layers of each residual feature map is n, n is a positive integer, and the attention network processes the image contents of the first image to obtain a coefficient feature map with a number of feature layers of n×m, the coefficient feature map is taken as the correction coefficients and is used to multiply with the residual feature map to correct parameters of the self-residual network.

According to some embodiments of the present disclosure, the first convolution network includes a first convolution layer and an activation function, and the second convolution network includes a second convolution layer.

According to some embodiments of the present disclosure, the first image is an image with a standard dynamic range, and the second image is an image with a high dynamic range.

According to some embodiments of the present disclosure, the method further includes: inputting the second image into an enhancement processing network for processing to obtain an enhanced second image, in which the enhancement processing network includes a noise reduction network and/or a color mapping network.

According to some embodiments of the present disclosure, the first image is a k-th frame of image in a video, and the second image is represented as an expanded k-th frame of image, k is an integer greater than 1, and the method further includes: using the inverse tone mapping neural network to process a (k−1)-th frame of image and a (k+1)-th frame of image in the video, respectively, to obtain an expanded (k−1)-th frame of image and an expanded (k+1)-th frame of image; and using a super-resolution network to process the expanded k-th frame of image, the expanded (k−1)-th frame of image and the expanded (k+1)-th frame of image, to obtain a super-resolution k-th frame of image, in which a resolution of the super-resolution k-th frame of image is higher than a resolution of the first image.

According to some embodiments of the present disclosure, the method further includes: using the super-resolution network to process a k-th frame of image, a (k−1)-th frame of image and a (k+1)-th frame of image in the video to obtain a super-resolution k-th frame of image, the super-resolution k-th frame of image is taken as the first image, in which a resolution of the first image is higher than a resolution of the k-th frame of image, k is an integer greater than 1.

According to some embodiments of the present disclosure, the inverse tone mapping neural network is trained by using a content loss function.

According to another aspect of the present disclosure, a computing system for image processing is also provided. The computing system for image processing includes: one or more processors; and one or more non-transitory computer-readable medium for storing instructions, the instructions, when executed by the one or more processors, cause the one or more processors to perform operations, and the operations include: using an inverse tone mapping neural network to process a first image, in which the inverse tone mapping neural network is configured to expand a dynamic range of the first image and a color gamut range of the first image to obtain a second image that is expanded, the inverse tone mapping neural network includes a mapping network, the mapping network is used to realize the expansion, and the inverse tone mapping neural network further includes an attention network, an input of the mapping network and an input of the attention network are both the first image, the attention network is used to process image contents of the first image to generate correction coefficients, and the correction coefficients are used to correct parameters of the mapping network.

According to some embodiments of the present disclosure, the mapping network includes a first convolution network, a self-residual network and a second convolution network, the mapping network being used to realize the expansion, includes: using the first convolution network to process the first image, to obtain a first feature map; using the self-residual network to process the first feature map, to obtain a second feature map; and using the second convolution network to process the second feature map, to obtain a third feature map, in which the third feature map is used as the second image, the correction coefficients are used to correct parameters of the self-residual network.

According to some embodiments of the present disclosure, the self-residual network includes m self-residual modules that are connected in sequence, m is an integer greater than 1, using the self-residual network to process the first feature map, includes: using a first processing path and a second processing path of a first self-residual module in the self-residual network to separately process the first feature map that is received to obtain a first residual feature map; using a first processing path and a second processing path of an i-th self-residual module in the self-residual network to separately process an (i−1)-th residual feature map that is obtained by an (i−1)-th self-residual module to obtain an i-th residual feature map, i is an integer greater than 1 and less than or equal to m, the first processing path includes a residual convolution layer, and the second processing path is used to skip processing of the residual convolution layer.

According to some embodiments of the present disclosure, a number of feature layers of each residual feature map is n, n is a positive integer, and the attention network processes the image contents of the first image to obtain a coefficient feature map with a number of feature layers of n×m, the coefficient feature map is taken as the correction coefficients and is used to multiply with the residual feature map to correct parameters of the self-residual network.

According to some embodiments of the present disclosure, the operations further include: inputting the second image into an enhancement processing network for processing to obtain an enhanced second image, in which the enhancement processing network includes a noise reduction network and/or a color mapping network.

According to some embodiments of the present disclosure, the first image is a k-th frame of image in a video, and the second image is represented as an expanded k-th frame of image, k is an integer greater than 1, and the operations further include: using the inverse tone mapping neural network to process a (k−1)-th frame of image and a (k+1)-th frame of image in the video, respectively, to obtain an expanded (k−1)-th frame of image and an expanded (k+1)-th frame of image; and using a super-resolution network to process the expanded k-th frame of image, the expanded (k−1)-th frame of image and the expanded (k+1)-th frame of image, to obtain a super-resolution k-th frame of image, in which a resolution of the super-resolution k-th frame of image is higher than a resolution of the first image.

According to some embodiments of the present disclosure, the operations further include: using the super-resolution network to process a k-th frame of image, a (k−1)-th frame of image and a (k+1)-th frame of image in the video to obtain a super-resolution k-th frame of image, the super-resolution k-th frame of image is taken as the first image, in which a resolution of the first image is higher than a resolution of the k-th frame of image, k is an integer greater than 1.

According to some embodiments of the present disclosure, the inverse tone mapping neural network is trained by using a content loss function, the first image is an image with a standard dynamic range, and the second image is an image with a high dynamic range.

According to yet another aspect of the present disclosure, an image processing device is also provided, which includes: a processor; and a memory, the memory stores computer-readable instructions, and the computer-readable instructions, when executed by the processor, perform the image processing method as described above.

According to yet another aspect of the present disclosure, a non-transitory computer-readable storage medium, on which instructions are stored, is also provided, the instructions, when executed by a processor, cause the processor to execute the image processing method as described above.

By using the image processing method, the computing system, the device, and the readable storage medium according to some embodiments of the present disclosure, the input first image can be processed by using the inverse tone mapping neural network, and the dynamic range of the first image and color gamut range of the first image can be expanded to obtain the second image that is expanded, the inverse tone mapping neural network includes the mapping network and the attention network that are used to realize the expansion. The input of the mapping network and the input of the attention network are both the first image. The attention network is used to process the image contents of the first image to generate the correction coefficients, which are used to correct the parameters of the mapping network. The attention network can be used to extract the content features of the input first image, so that the correction coefficients that are obtained are closely related to the image contents, and the correction coefficients are used to adjust the parameters of the mapping network, so as to improve the ability of the mapping network to expand the color gamut and dynamic mapping of the image, and improve the visual effect of the converted image.

### BRIEF DESCRIPTION OF THE DRAWINGS

In order to clearly illustrate the technical solution of the embodiments of the invention, the drawings of the embodiments will be briefly described in the following: it is obvious that the described drawings are only related to some embodiments of the invention and thus are not limitative of the invention.

FIG. 1 is a schematic flow chart of an image processing method according to embodiments of the present disclosure;

FIG. 2 is a schematic structure diagram of an inverse tone mapping neural network according to embodiments of the present disclosure;

FIG. 3 is another schematic structure diagram of the inverse tone mapping neural network according to embodiments of the present disclosure:

FIG. 4A is a network structure diagram of a mapping network according to embodiments of the present disclosure:

FIG. 4B is a network structure diagram of a self-residual module according to embodiments of the present disclosure:

FIG. 5 is a network structure diagram of an attention network according to embodiments of the present disclosure:

FIG. 6 is another schematic flow chart of the image processing method according to embodiments of the present disclosure;

FIG. 7A is an application flow chart of the image processing method according to embodiments of the present disclosure;

FIG. 7B is another application flow chart of the image processing method according to embodiments of the present disclosure;

FIG. 8A is a network structure diagram of a noise reduction network according to embodiments of the present disclosure:

FIG. 8B is a network structure diagram of a residual network ResNet in the noise reduction network according to embodiments of the present disclosure;

FIG. 9A is a schematic diagram of a color mapping network according to embodiments of the present disclosure;

FIG. 9B is a schematic diagram of training process of the color mapping network;

FIG. 10A is a network structure diagram of a super-resolution network according to embodiments of the present disclosure:

FIG. 10B is a network structure diagram of an alignment network in the super-resolution network according to embodiments of the present disclosure;

FIG. 11 is a schematic diagram of a computing system according to embodiments of the present disclosure;

FIG. 12 is a schematic block diagram of an image processing device according to embodiments of the present disclosure;

FIG. 13 is a schematic block diagram of a video processing device according to embodiments of the present disclosure;

FIG. 14 is a schematic diagram of the architecture of an exemplary computing device according to embodiments of the present disclosure; and

FIG. 15 is a schematic diagram of a computer storage medium according to embodiments of the present disclosure.

### DETAILED DESCRIPTION

In order to make objects, technical details and advantages of the embodiments of the present disclosure, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

The terms “first,” “second,” etc., which are used in the present disclosure, are not intended to indicate any sequence, amount or importance, but distinguish various components. The terms “comprise.” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly.

Flow charts are used in this disclosure to illustrate the steps of a method according to embodiments of the disclosure. It should be understood that the preceding or subsequent steps do not necessarily have to be performed in a precise order. Instead, various steps may be processed in reverse order or concurrently. Other operations can also be added to these procedures.

It can be understood that the technical terms and nouns involved in this article have the meanings known to those skilled in the art.

Artificial Intelligence (AI) is a theory, method, technology and application system that uses digital computers or machines that is digital computer controlled to simulate, extend and expand human intelligence, sense the environment, acquire knowledge and use knowledge to obtain the best results. In other words, Artificial intelligence is a comprehensive technology of computer science, which attempts to understand the essence of intelligence and produce a new intelligent machine that can react in a similar way to human intelligence. Artificial intelligence is principles and implementation modes to study the design of various intelligent machines, so that the machines have the functions of perception, reasoning and decision-making.

Artificial intelligence technology is a comprehensive discipline, involving a wide range of fields, comprising both hardware level technology and software level technology. AI software technology mainly comprises several directions such as computer vision technology, voice processing technology, natural language processing technology and machine learning/deep learning. The neural network is trained based on training samples. For example, image processing can be realized to transform the display effects of the image.

The present disclosure provides an image processing method based on neural networks, in which an inverse tone mapping neural network is used to process an input image and expand the dynamic range and color gamut range of the image to obtain an image that is expanded. Specifically, the inverse tone mapping neural network comprises the mapping network used to realize the above expansion, and also comprises an attention network. The input information of the mapping network and the attention network are both input images that are received. The attention network is used to process image contents to generate correction coefficients, which are used to correct parameters of the mapping network. The image processing method according to embodiments of the present disclosure can use the attention network to extract the content features of the input image, so that correction coefficients that are obtained are closely related to the image contents, and the correction coefficients are used to adjust the parameters of the mapping network, so as to improve the ability of the mapping network to expand the color gamut and dynamic mapping of the image, and improve the visual effect of the converted image.

In the embodiments according to the present disclosure, the inverse tone mapping neural network is used to improve the dynamic range of the image, for example, to convert the image originally corresponding to a Standard Dynamic Range (SDR) into the image corresponding to a High Dynamic Range (HDR). Compared with the SDR image, the HDR image uses more bits to represent brightness and chroma, in which the picture information contents are greater, and the light and shadow details are richer.

FIG. 1 is a schematic flow chart of an image processing method according to the embodiments of the present disclosure. Firstly, in step S101, the inverse tone mapping neural network is used to process a first image, the inverse tone mapping neural network is configured to expand a dynamic range of the first image and a color gamut range of the first image to obtain a second image that is expanded. The inverse tone mapping neural network can include a mapping network, which is used to realize the above expansion. In addition, according to the embodiments of the present disclosure, the inverse tone mapping neural network can further include an attention network, an input of the mapping network and an input of the attention network are both the first image. The attention network is used to process the image contents of the first image to generate correction coefficients, and the correction coefficients are used to correct parameters of the mapping network.

According to the embodiments of the present disclosure, in the process of image processing by using the mapping network, the attention network is also introduced, which is used to extract features of the original input image information and generate correction coefficients to correct the parameters of the mapping network by using the correction coefficients that are related to the image content information, so as to improve the expansion ability of the mapping network for the dynamic range and color gamut range of the image, and to improve the image display effect after inverse tone mapping.

According to some embodiments of the present disclosure, the first image may be one picture or one of the pictures in a video or an image sequence, which is not limited here. As an example, the first image may be an image corresponding to SDR, and the second image that is obtained after processing may be an image corresponding to HDR, which is not limited here.

According to some embodiments of the present disclosure, the mapping network may include a first convolution network, a self-residual network and a second convolution network. The mapping network is used to realize the above expansion steps, which specifically include: using the first convolution network to process the first image to obtain a first feature map; using the self-residual network to process the first feature map to obtain a second feature map; and using the second convolution network to process the second feature map to obtain a third feature map, the third feature map is used as the above second image. According to some embodiments of the present disclosure, the correction coefficients that are generated by the above attention network is used to correct parameters of the self-residual network.

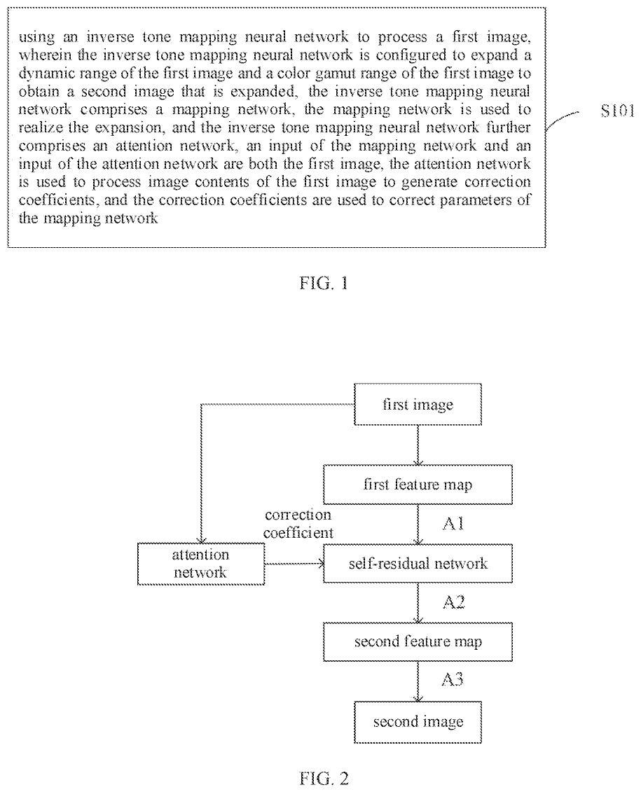

FIG. 2 is a schematic structure diagram of an inverse tone mapping neural network according to the embodiments of the present disclosure. As shown in FIG. 2, the input information of the first convolution network in the mapping network and the input information of the attention network are both original first image. The first convolution network is used to process the received first image to obtain the first feature map A1, and the self-residual network is used to process the first feature map A1 to obtain the second feature map A2. In addition, the attention network is used to process the received first image to obtain the correction coefficients, which are used to adjust the coefficients of the self-residual network. Next, the second convolution network is used to process the received second feature map A2 to obtain the third feature map A3. The third feature map A3 is output as the above second image, for example, output as an image with a high dynamic range. The process of generating correction coefficients by the attention network and performing coefficient correction on the self-residual network based on correction coefficients will be described in detail below.

According to some embodiments of the present disclosure, the self-residual network may include m self-residual modules connected in sequence, where m is an integer greater than 1, using the self-residual network to process the first feature map includes: using a first processing path and a second processing path of a first self-residual module in the self-residual network to separately process the first feature map that is received to obtain a first residual feature map; and using a first processing path and a second processing path of an i-th self-residual module in the self-residual network to separately process an (i−1)-th residual feature map that is obtained by an (i−1)-th self-residual module to obtain an i-th residual feature map, where i is an integer greater than 1 and less than or equal to m, the first processing path includes a residual convolution layer, and the second processing path is used to skip processing of the residual convolution layer. It can be understood that in the self-residual network, the self-residual modules that are connected in sequence have the same network structure.

According to some embodiments of the present disclosure, a number of feature layers of each residual feature map is n, n is a positive integer, and the attention network processes the image contents of the first image to obtain a coefficient feature map with a number of feature layers of n×m, the coefficient feature map is taken as the correction coefficients and is used to multiply with the residual feature map to correct parameters of the self-residual network.

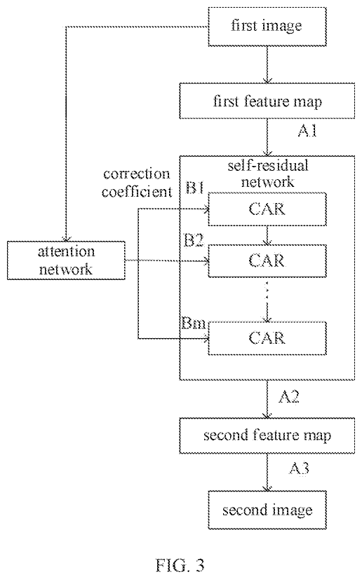

FIG. 3 is another schematic structure diagram of the inverse tone mapping neural network according to the embodiments of the present disclosure. As shown in FIG. 3, the self-residual modules in the self-residual network can represent CAR and are connected with each other in sequence. The number of feature layers of the self-residual feature map generated by the self-residual module can be n=64, that is, the feature map has 64 layers of features, and the attention network is configured to generate the coefficient feature map with the number of feature layers of n×m based on the first image, to correct the coefficients of m self-residual modules, respectively.

As an example, for the coefficient feature map of n×m, the feature map of the (1-n)-th layer (represented as B1) is used to correct the parameters of the first self-residual module, the feature map of the ((n+1)−(2n))-th layer (represented as B2) is used to correct the parameters of the second self-residual module, and so on, and the feature map of ((n×(m−1)+1)−n×m)-th layer (represented as Bm) is used to correct the parameters of the m-th self-residual module.

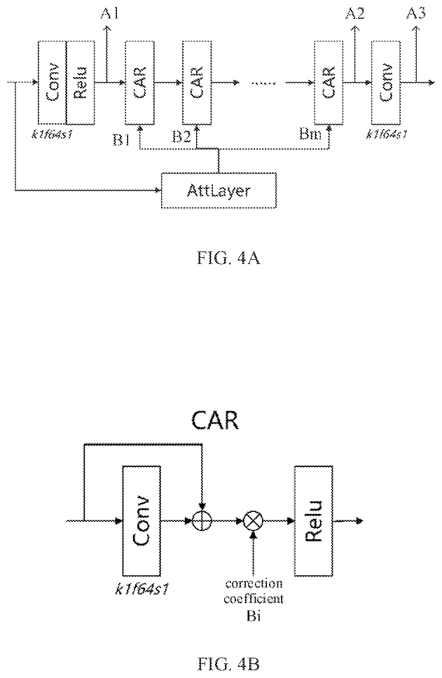

As an implementation mode. FIG. 4A is a network structure diagram of a mapping network according to the embodiments of the present disclosure, and FIG. 4B is a network structure diagram of a self-residual module according to the embodiments of the present disclosure. The network structure of the inverse tone mapping neural network according to the embodiments of the present disclosure will be described below in combination with FIG. 4A and FIG. 4B.

As shown in FIG. 4A, according to some embodiments of the present disclosure, the first convolution network includes a first convolution layer Conv and an activation function Relu. The network parameter of the first convolution layer Cony is expressed as k1f64s1. k1 indicates that the convolution kernel size of the first convolution layer Conv is 1, f64 indicates that the number of feature layers is 64, and s1 indicates that the step size is 1. The first convolution network Conv adopts 1×1 convolution, performs pixel-level point-to-point space mapping on the input first image, and then obtains the first feature map A1 through the activation function Relu, the convolution operation is a linear operation, and the nonlinear function Relu is used to activate neurons. In addition, Relu can also overcome the problem of gradient disappearance and speed up the training speed of the neural network.

Next, the self-residual network is composed of m self-residual modules CAR that are connected in sequence, each self-residual module has the same network structure. As shown in FIG. 4B, for example, the self-residual module CAR includes two processing paths, one of which (the first processing path) includes a self-residual convolution layer. The network parameter of the self-residual convolution layer, for example, can also be k1f64s1, which is used to perform convolution processing on received information to extract image features. As shown in FIG. 4B, another processing path (the second processing path) of the self-residual module is used to skip processing of the self-residual convolution layer, so that the received information is directly added to the processing results of the first processing path, that is, self-residual is realized. The self-residual network structure can realize the residual ability without introducing redundant computation, which effectively improves the processing and training efficiency of the model.

Then, as shown in FIG. 4B, the processing results through the first processing path and the second processing path of the self-residual module will be multiplied by correction coefficients from an Attention Layer (AttLayer). Taken the i-th self-residual module shown in FIG. 4B as an example, the correction coefficient Bi will be multiplied, and the results after multiplying the correction coefficient will be output to the i-th self-residual module through the activation function Relu.

In combination with FIG. 4A and FIG. 4B, it can be understood that for the mapping network and network parameter k1f64s1 in FIG. 4A, the attention network AttLayer generates a coefficient feature map of 64/m accordingly to serve as coefficients B1, B2 . . . and Bm, respectively, to be used to multiply the feature map before the Relu processing in the self-residual module, so as to make more precise coefficient adjustment on the output of the mapping network. This is equivalent to multiplying the output of each CAR by a matrix coefficient, which is obtained by extracting the image features by the input first image through the attention network. This matrix coefficient is closely related to the content features of the input image, that is, using the feature information of the current image to finely adjust the mapping network to improve the display effect of the converted image. Next, as shown in FIG. 4A, the first feature map A1 is processed by the self-residual network to obtain the second feature map A2, and the second convolution network receives the second feature map A2. The second convolution network includes a second convolution layer, of which network parameter is k1f64s1, and the third feature map A3 is obtained.

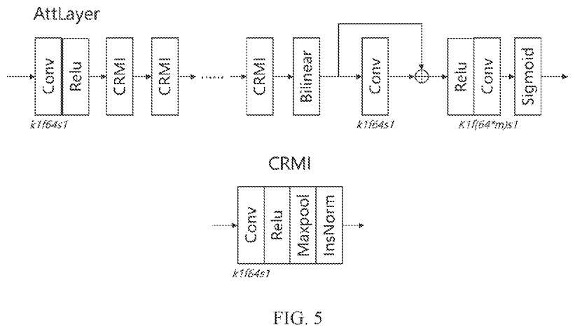

FIG. 5 is a network structure diagram of an attention network AttLayer according to the embodiments of the present disclosure. The network structure and network parameters of the attention network according to the embodiments of the present disclosure will be described below in combination with FIG. 5.

As shown in FIG. 5, the attention network AttLayer includes the convolution layer Cony and the activation function Relu. The network parameter of the convolution layer is k1f64s1, that is, 1×1 convolution is adopted to perform pixel-level point-to-point space mapping on the input first image, the number of feature layers is 64 and the step size is 1. Then, the attention network AttLayer may include several CRMI network modules, and the specific structure of the CRMI module is shown in the lower part of FIG. 5. It can be understood that the number of CRMI can be set according to processing requirements, and the network structure of each CRMI is the same. Specifically, the CRMI network module may include the convolution layer Conv and the activation function Relu. Next, the network further includes a maximum pooling layer (Maxpool) and an instance normalization layer (InsNorm). The pooling layer reduce the dimension of data by imitating the human visual system and represent the image with higher-level features. The purpose of implementing the pooling layer is to reduce information redundancy, improve the scale invariance and rotation invariance of the model, and prevent over-fitting. The pooling layer is generally placed behind the convolution layer.

As shown in FIG. 5, following the CRMI network module in the attention network AttLayer, there is a bilinear processing layer (Bilinear) and a self-residual network. A processing path of the self-residual network includes a convolution layer, of which the parameter is k1f64s1. Then, it is processed by Relu and the convolution layer. The network parameter of the convolution layer is set to k1f(n×m)s1, that is, the number of feature layers of the coefficient feature map, which is output through the convolution layer, is n×m. And the feature layers is processed through the Sigmoid function, to do a dot product with the output of the self-residual module in FIG. 4A, respectively, to realize coefficient adjustment, that is, to adjust the features that are output by the self-residual network. Since the coefficients used for adjustment are from the extraction of the attention feature of the input first image, which makes the adjusted feature map pay more attention to the overall features of the input image, so as to achieve better image conversion effect. It can be understood here that the Sigmoid function is used as an activation function in the attention network, and maps variables to 0-1.

According to some embodiments of the present disclosure, the image processing method may further include: inputting the second image into an enhancement processing network for processing to obtain an enhanced second image, the enhancement processing network includes a noise reduction network and/or a color mapping network.

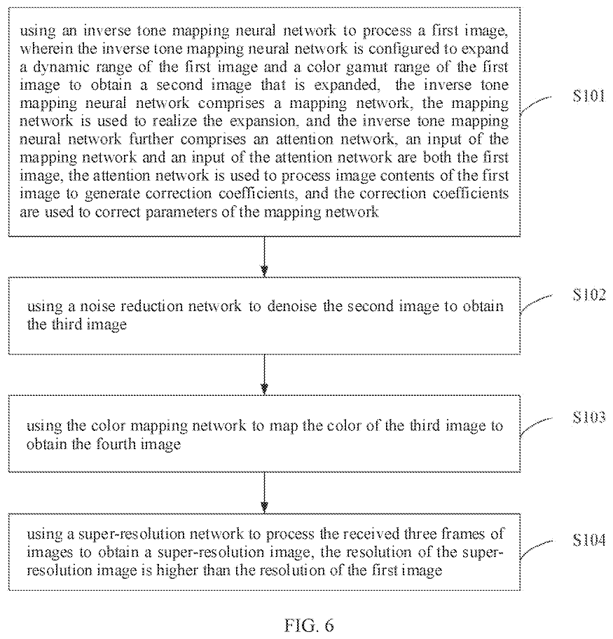

Specifically, FIG. 6 is another schematic flow chart of the image processing method. As shown in FIG. 6, the image processing method can further include steps S102 and S103. In step S102, a noise reduction network is used to denoise the second image to obtain the third image; and in step S103, the color mapping network is used to map the color of the third image to obtain the fourth image. It can be understood that the image processing method according to the embodiments of the present disclosure can perform one of the above steps S102 and S103, or both. In the case of the above two, the sequence of steps S102 and S103 is adjustable, which will not be limited here.

In addition, as shown in FIG. 6, the image processing method can further include step S104: using a super-resolution network to process the received three frames of images to obtain a super-resolution image, the resolution of the super-resolution image is higher than the resolution of the first image.

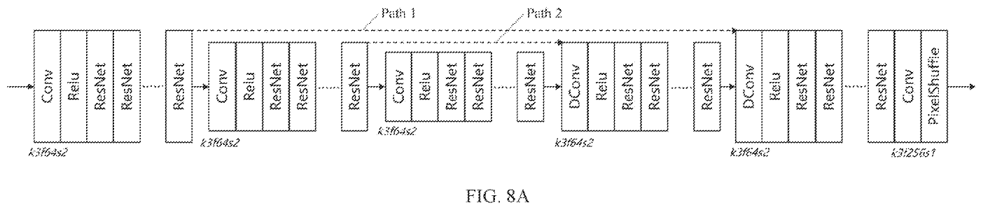

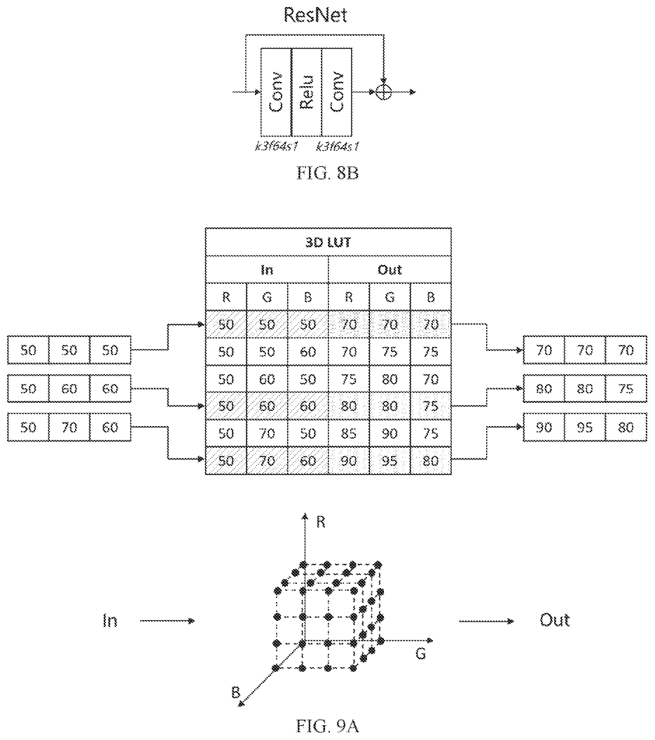

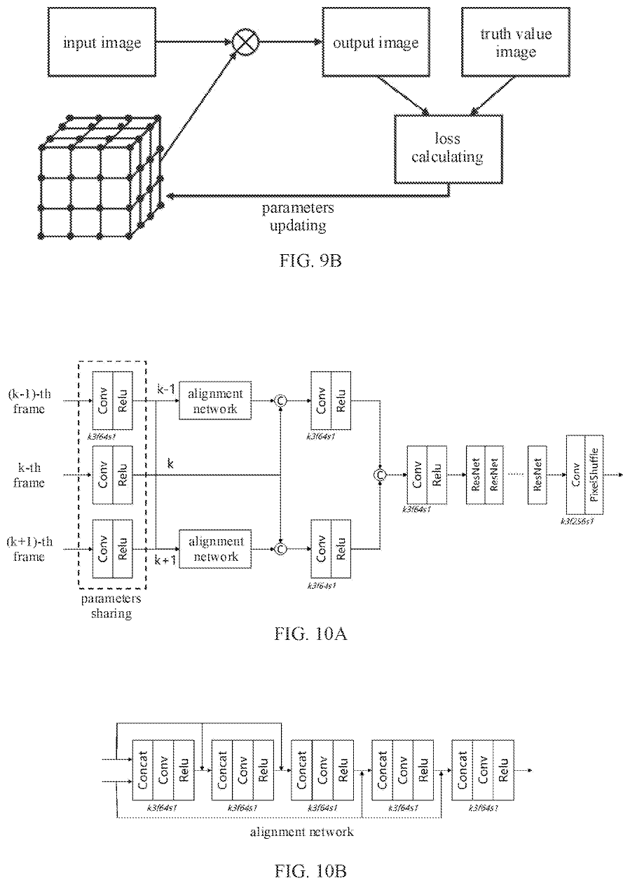

After the processing of the inverse tone mapping neural network, the brightness, contrast and other parameters of the image are improved, which will make the noise interference in the image more obvious. Therefore, the noise reduction network can be used to denoise the image to reduce the noise disturbance. The network structure of the noise reduction network will be described below in combination with FIG. 8A and FIG. 8B.

The color mapping network is used for color mapping processing of images. For example, the image processor may choose to use this color mapping network in a case that the image needs to show warm tone, cold tone, black and white tone and other subjective color toning intentions. Multiple 3-Dimensional Lookup Table (3D LUT) templates are used to perform color mapping of the image. The implementation process of this color mapping network will be described below in combination with FIG. 9A.

In addition, the super-resolution network is used to improve the resolution of the image to meet super-resolution display requirements. For example, the resolution of the original input first image can be 2K, and after super-resolution network processing, the resolution is increased to 4K. The network structure of the super-resolution network will be described below in combination with FIG. 10A and FIG. 10B.

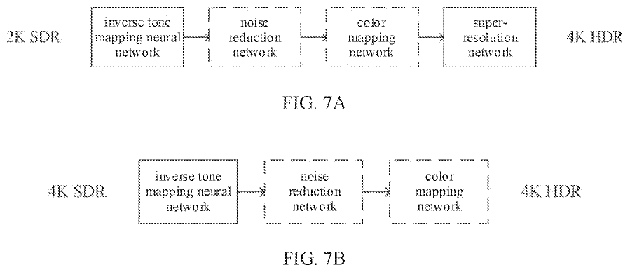

FIG. 7A is an application flow chart of the image processing method according to the embodiments of the present disclosure. As an example, suppose that the input first image is an SDR image with a resolution of 2K. Firstly, the expansion of the dynamic range and color gamut range can be achieved by the processing of the inverse tone mapping neural network. The second image that is obtained after processing will be an HDR image with a resolution of 2K, then it can be processed through the noise reduction network and the color mapping network, respectively. Finally, the resolution of the image can be increased to 4K through the super-resolution network to achieve the effect of super-resolution image display.

FIG. 7A only shows the processing flow of the image processing method according to some embodiments of the present disclosure. It can be understood that, in other embodiments, for example, the noise reduction network and the color mapping network can be selectively applied, or the processing order of the two can be adjusted. In some embodiments, the processing process of the noise reduction network and the color mapping network can also be omitted, and the super-resolution processing can be directly performed after the inverse tone mapping processing. For example, the resolution of the first image output by the inverse tone mapping neural network can be increased from 2K to 4K.

In addition, in other embodiments according to the present disclosure, the super-resolution processing process can also be performed first. Specifically, before the inverse tone mapping, the image processing method includes: using the super-resolution network to process the k-th frame of image, the (k−1)-th frame of image and the (k+1)-th frame of image in the video to obtain a super-resolution k-th frame of image, and the super-resolution k-th frame of image is taken as the first image, the resolution of the first image is higher than the resolution of the k-th frame of image, where k is an integer greater than 1. That is, firstly, the resolution of the image is improved based on the adjacent frame information in the video, and then the inverse tone mapping neural network is used to perform inverse tone mapping on the image with improved resolution to obtain an HDR image. It can be understood that continuous images in the video have the same resolution. For example, the k-th frame of image, the (k−1)-th frame of image and the (k+1)-th frame of image in the video have the same resolution. The current k-th frame of image and its adjacent frame of image (i.e., the (k−1)-th frame of image and the (k+1)-th frame of image) are processed through the super-resolution network to obtain the k-th frame of image with improved resolution, for example, the super-resolution image.

It can be understood that the sequence of steps S101-S104 shown in FIG. 6 above is adjusted according to actual application situation, or only some of the steps are performed.

FIG. 7B is another application flow chart using the image processing method according to the embodiments of the present disclosure. In the example of FIG. 7B, the input first image itself has a 4K resolution. In this case, the processing of the super-resolution network may not be performed.

According to some embodiments of the present disclosure, the process of resolution enhancement of the super-resolution network does not change the color content information of the image, but perform pixel supplement for the resolution of the image, for example, the resolution of the image is doubled, that is, 1 pixel is expanded to 4 pixels. Therefore, in order to obtain a 4K HDR image, it can be chosen to improve the resolution of the image in first step to obtain 4K resolution, and then perform a series of image processing operations such as inverse tone mapping, noise reduction and other operations on the basis of the image with 4K resolution. Or, preferably, it can be chosen to perform inverse tone mapping, noise reduction and other operations first on the basis of the image with 2K resolution, and then increase the resolution of the image to 4K in the last step, which can save the computing cost of image processing.

FIG. 8A is a network structure diagram of a noise reduction network according to the embodiments of the present disclosure. As shown in FIG. 8A, as an implementation mode, a Unet network structure is adopted by the noise reduction network according to some embodiments of the present disclosure. Firstly, through the convolution layer Cony and the activation function Relu, the network parameter of the convolution layer is k3f64s2, which means that the convolution kernel is 3, the number of feature layers is f=64, and the step length is s=2, that is, two times of down-sampling is performed. Then, several residual networks (ResNet) can be set. FIG. 8B is a network structure diagram of a residual network ResNet in the noise reduction network, in which the first processing path includes the convolution layer k3f64s1, the activation function Relu, and the other convolution layer k3f64s1, and the second processing path is used to skip the processing of the two convolution layers and the activation function above to achieve the residual structure. Similarly, the number of the residual network ResNet can be set according to actual processing requirements, which is not limited here.

Then, as shown in FIG. 8A, after ResNet, it is the Unet connection structure, that is, there are processing paths (Path 1 and Path 2) to realize cross-level connection. In the noise reduction network, there is also a deconvolution layer DConv. of which network parameter is k3f64s2, which means that the convolution kernel is k=3, the number of feature layers is f=64, and the step length is s=2, that is, 2 times upper sampling is realized. The specific network structure and parameters of the noise reduction network can be referred to FIG. 8A and will not be described one by one. Referring to FIG. 8A, the network parameter of the last convolution layer Conv is k3f256s1, that is, the number of output feature layers is 256, and then the final image is output through PixelShuffle (2 times upper sampling). PixelShuffle can be understood as a low-resolution image of H×W which is converted to a high-resolution image of rH×rW by sub-pixel operation. However, the process of PixelShuffle achieving resolution improvement is not directly generated by interpolation, but by periodic shuffing to obtain a high-resolution image. For example, the network parameter of the convolution layer before PixelShuffle is f=256, that is, the number of feature layers is 256. After PixelShuffle, the output image with 64 feature layers but with improved image resolution will be obtained.

It can be understood that in addition to the noise reduction network structure shown in FIG. 8A and FIG. 8B, other open source noise reduction network models can also be used for processing, such as ArCNN, DnCNN, MeshFlow, and so on. It is only necessary to update the model parameters according to an actual data set.

FIG. 9A is a schematic diagram of the color mapping network according to the embodiments of the present disclosure. According to the embodiments of the present disclosure, the color mapping network can use multiple 3-Dimensional Lookup Tables (3D LUT) as mapping templates to realize color mapping of images, such as color conversion of cold tones, warm tones, etc. The 3D LUT can be regarded as a three-dimensional matrix that is obtained by training the deep learning model. Each 3D LUT is a color mapping template. The color mapping network can be designed with multiple templates, such as templates with black and white tone, warm tone, cool tone, and any other tones for image processing. 3D LUT is to find the corresponding output value according to the RGB value of the input image. For example, for the value (50, 50, 50) of the 3-color channel of the input (In), the color output value Out, such as (70, 70, 70), will be found correspondingly. Therefore, the color conversion will be realized through the lookup table.

Compared with the 1-dimensional lookup table, which can only control single-channel color output, and each channel output is independent of each other, the output of 3D LUT is RGB three-channel, and all are correlated, which is conducive to improving the color processing effect. In addition, the 3D lookup table has a large capacity. For example, a 64-order lookup table can have more than 260,000 color output values, which makes the output of color brightness more accurate and realistic. Moreover, the lookup table data with large capacity can also save subjective information such as brightness, color, detail preference, etc., which is more conducive to the realization of color mapping tasks.

According to Some Embodiments of the Present Disclosure, 3D LUT can be Expressed by the Following Formula:

$$U = \{ {μ}_{( i , j , k )}^{c} \vert i , j , k = 0 , 1 , 2 , … , N , c ∈ \{ r , g , b \} \}$$

Where (i, j, k) corresponds to the space system coordinates of 3-color channels R, G and B, respectively. The mapping relationship of the 3D lookup table can be expressed as: input pixel{(I_{(i,j,k)}^{r}, I_{(i,j,k)}^{g}, I_{(i,j,k)}^{b}} and the mapped output pixel value is:

$$\{ {O}_{( i , j , k )}^{c} \vert c ∈ \{ r , g , b \} \} = {μ}_{( i , j , k )}^{c} \{ {I}_{( i , j , k )}^{r} , {I}_{( i , j , k )}^{g} , {I}_{( i , j , k )}^{b} \}$$

FIG. 9B is a schematic diagram of training process of the color mapping network. Firstly, the current 3D LUT realizes the color conversion processing of the input image to obtain the output image, and then a loss value can be calculated based on a preset truth value image and the output image to adjust the parameters of the lookup table based on the loss value, so that the display effect of the output image, which is obtained based on the lookup table, is closer to a target truth value image. Thus, the training process of the lookup table is realized. Specifically, a loss function, which is used to calculate the loss value in the model, can use a content loss function, for example.

The loss function used in the above training process can be the content loss function. For example, the mean square error loss function MSE can be used to calculate a sum of squares of the difference values between a prediction value and a target value. For another example, an L1 norm loss function, also known as a minimum absolute deviation (LAD) function, can also be used to minimize the sum of the absolute difference values between the target value (Yi) and the prediction value (f(xi)). For another example, an L2 norm loss function, also known as a least square error (LSE) function, can also be used to minimize the sum of squares of the difference values between the target value (Yi) and the prediction value (f(xi)).

FIG. 10A is a network structure diagram of a super-resolution network according to some embodiments of the present disclosure. As shown in FIG. 10A, the super-resolution network according to some embodiments of the present disclosure can receive 3 frames of video images as input.

In some applications, the image processing method provided by the embodiments of the present disclosure can be applied not only to single image processing, but also to video processing. In this case, the above first image can be one frame of image in the video. In the process of realizing super-resolution expansion, receiving 3 frames of images is conducive to extracting more detailed image information from the video sequence, so that the image with improved resolution have better display effect. Taking the first image that is currently processed as the k-th frame of image in the video as an example, the super-resolution network shown in FIG. 10A can receive the processing results of the (k−1)-th frame of image, the k-th frame of image and the (k+1)-th frame of image, for example, it has been processed by the inverse tone mapping neural network before being processed by the super-resolution network.

Specifically, as shown in FIG. 10A, firstly, the received three frames of images are processed through the network with the same parameters, and the parameters will be shared, that is, the convolution layer k3f64s1 and the activation function Relu shown with dotted lines in FIG. 10A. Next, the processing results of the (k−1)-th and the k-th frame of image enter the alignment network AlignNet, while the processing results of the (k+1)-th and the k-th frame of image enter another alignment network, the alignment network is used to align the feature information of the multi-frame input images.

FIG. 10B is a network structure diagram of an alignment network in the super-resolution network. As shown in FIG. 10B, the alignment network receives two input information, and firstly performs feature fusion through the Contact structure, which is used to integrate two sets of input feature map information and increase the number of channels of the feature map. For example, the number of layers of the feature map of the input (k−1)-th frame of image and the number of layers of the feature map of the k-th frame of image are both 64. After Contact, a feature map with 128 feature layers is formed. The specific network structure and parameters of the super-resolution network and the alignment network can refer to FIG. 10A and FIG. 10B, which will not be described here.

It can be understood that in addition to the super-resolution network structure shown in FIG. 10A and FIG. 10B, other open source super-resolution network models (such as DUF, EDSR, EDVR and other networks) can also be used for processing, which only need to update the model parameters according to actual data sets.

According to the embodiments of the present disclosure, the inverse tone mapping neural network is trained by using a content loss function. Similarly, the noise reduction network and the super-resolution network can also be trained, separately, and finally used in combination. The training process of the above network is similar to the training process described in FIG. 9B, and the used loss function can also be the above content loss functions L1, L2, MSE, etc., which will not be repeated here.

By using the image processing method according to some embodiments of the present disclosure, the input first image can be processed by using the inverse tone mapping neural network, and the dynamic range of the first image and color gamut range of the first image can be expanded to obtain the second image that is expanded, the inverse tone mapping neural network includes the mapping network and the attention network that are used to realize the expansion. The input of the mapping network and the input of the attention network are both the first image. The attention network is used to process the image contents of the first image to generate correction coefficients, which are used to correct the parameters of the mapping network. The attention network can be used to extract the content features of the input first image, so that the correction coefficients that are obtained are closely related to the image contents, and the correction coefficients are used to adjust the parameters of the mapping network, so as to improve the ability of the mapping network to expand the color gamut and dynamic mapping of the image, and improve the visual effect of the converted image.

Furthermore, the noise reduction network, the color mapping model and the super-resolution network provided by the embodiments of the present disclosure can be further used to further process the image according to the image processing requirements to improve the display effect of the image.

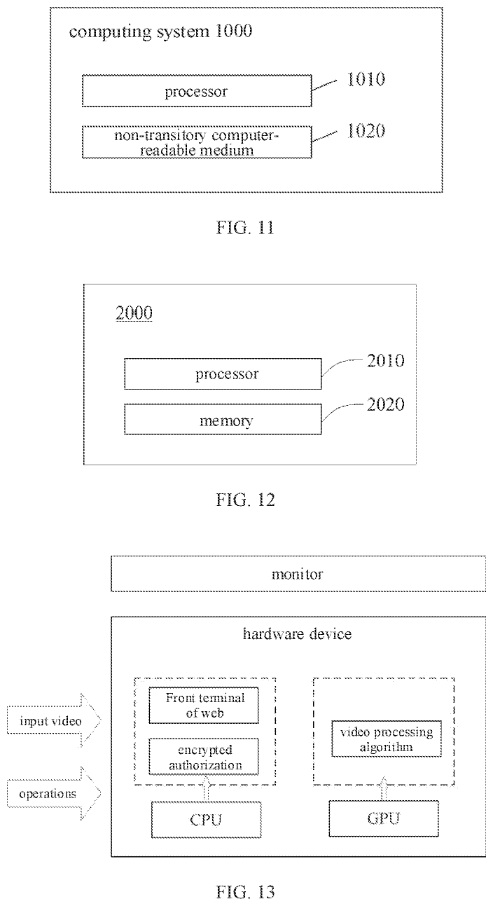

The present disclosure also provides a computing system for image processing. Specifically, FIG. 11 is a schematic block diagram of a computing system for image processing according to the embodiments of the present disclosure.

As shown in FIG. 11, the computing system 1000 for image processing may include one or more processors 1010 and one or more non-transitory computer-readable medium 1020 for storing instructions.

According to some embodiments of the present disclosure, the instructions, which are stored in the non-transitory computer-readable medium 1020, when executed by one or more processors 1010, cause the one or more processors to perform operations. The operations include: using an inverse tone mapping neural network to process a first image, the inverse tone mapping neural network is configured to expand a dynamic range of the first image and a color gamut range of the first image to obtain a second image that is expanded, the inverse tone mapping neural network includes a mapping network, the mapping network is used to realize the expansion, and the inverse tone mapping neural network further includes an attention network, an input of the mapping network and an input of the attention network are both the first image, the attention network is used to process the image contents of the first image to generate correction coefficients, and the correction coefficients are used to correct parameters of the mapping network.

According to some embodiments of the present disclosure, the mapping network includes a first convolution network, a self-residual network and a second convolution network. The mapping network is used to realize the expansion which includes: using the first convolution network to process the first image to obtain the first feature map; using the self-residual network to process the first feature map to obtain the second feature map; and using the second convolution network to process the second feature map to obtain the third feature map, in which the third feature map is used as the second image, and the correction coefficients are used to correct the parameters of the self-residual network. According to some embodiments of the present disclosure, the first convolution network includes a first convolution layer and an activation function, and the second convolution network includes a second convolution layer. As an example, the specific network structure of the mapping network can be referred to the description above in FIG. 4A, which will not be repeated here.

According to some embodiments of the present disclosure, the self-residual network includes m self-residual modules that are connected in sequence, where m is an integer greater than 1, using the self-residual network to process the first feature map includes: using a first processing path and a second processing path of a first self-residual module in the self-residual network to separately process the first feature map that is received to obtain a first self-residual feature map; using a first processing path and a second processing path of the i-th self-residual module in the self-residual network to separately process an (i−1)-th self-residual feature map that is obtained by an (i−1)-th self-residual module to obtain an i-th self-residual feature map, where i is an integer greater than 1 and less than or equal to m, the first processing path includes a self-residual convolution layer, and the second processing path is used to skip processing of the self-residual convolution layer. As an example, the specific network structure of the self-residual module can be referred to the description above in FIG. 4B, which will not be repeated here.

According to some embodiments of the present disclosure, a number of feature layers of each self-residual feature map is n, and n is a positive integer. The attention network processes the image contents of the first image to obtain a coefficient feature map with a number of feature layers of n×m, the coefficient feature map is taken as the correction coefficients and is used to multiply with the self-residual feature map to correct the parameters of the self-residual network. As an example, the specific network structure of the attention network can be referred to the description above in FIG. 5, which will not be repeated here.

According to some embodiments of the present disclosure, the first image is an image with a standard dynamic range, and the second image is an image with a high dynamic range.

According to some embodiments of the present disclosure, the above operations may also include inputting the second image into an enhancement processing network for processing to obtain an enhanced second image, the enhancement processing network includes a noise reduction network and/or a color mapping network. As an example, the specific network structure of the noise reduction network can be referred to the description above in combination with FIG. 8A and FIG. 8B, which will not be repeated here. Similarly, the color mapping network can be referred to the description above in FIG. 9A, which will not be repeated here. According to some embodiments of the present disclosure, one or both of the above noise reduction process and color mapping process as well as the execution order of the both can be selected according to actual needs, which is not limited here.

According to some embodiments of the present disclosure, the first image is a k-th frame of image in a video, and the second image is represented as an expanded k-th frame of image, where k is an integer greater than 1.

According to some embodiments of the present disclosure, the above operations can also include: using the inverse tone mapping neural network to process a (k−1)-th frame of image and a (k+1)-th frame of image in the video, respectively, to obtain an expanded (k−1)-th frame of image and an expanded (k+1)-th frame of image, and using a super-resolution network to process the expanded k-th frame of image, the expanded (k−1)-th frame of image and the expanded (k+1)-th frame of image to obtain a super-resolution k-th frame of image, a resolution of the super-resolution k-th frame of image is higher than a resolution of the first image. As an example, the specific network structure of super-resolution network can be referred to the description above in combination with FIG. 10A and FIG. 10B, which will not be repeated here. In this part of the embodiment, the image in the video is firstly processed by inverse tone mapping to achieve the conversion from SDR to HDR, and then the resulting HDR image is processed by super resolution to obtain the super-resolution HDR image.

According to some embodiments of the present disclosure, the above operations can also include: using the super-resolution network to process a k-th frame of image, a (k−1)-th frame of image and a (k+1)-th frame of image in the video to obtain the super-resolution k-th frame of image, and the super-resolution k-th frame of image is taken as the first image, a resolution of the super-resolution first image that is obtained is higher than the resolution of the k-th frame of image, where k is an integer greater than 1. In this part of the embodiment, three frames of images in the video are first processed by the super-resolution network to obtain the super-resolution first image, and the super-resolution first image is then processed by the inverse tone mapping neural network to achieve the conversion from SDR to HDR.

According to Some Embodiments of the Present Disclosure, the Inverse Tone Mapping Neural Network is Trained by Using a Content Loss Function.

According to another aspect of the present disclosure, an image processing device is further provided. FIG. 12 is a schematic block diagram of an image processing device according to the embodiments of the present disclosure.

As shown in FIG. 12, the device 2000 can include a processor 2010 and a memory 2020. According to the embodiments of the present disclosure, the computer-readable codes are stored in the memory 2020. The computer-readable codes, when executed by the processor 2010, execute the image processing method described above.

The processor 2010 can perform various actions and processes according to the programs stored in the memory 2020. Specifically, the processor 2010 can be an integrated circuit chip with signal processing capability. The above processor can be a general-purpose processor, a digital signal processor (DSP), an application specific integrated circuit (ASIC), a field programmable gate array (FPGA) or other programmable logic devices, discrete gates or transistor logic devices, and discrete hardware components, which can implement or perform various methods, steps, and logic block diagrams disclosed in the embodiments of the present disclosure. The general-purpose processor can be a microprocessor or the processor, and the general-purpose processor can also be any conventional processor.

The memory 2020 stores computer executable instruction codes, which are used to implement the image processing method according to the embodiments of the present disclosure when executed by the processor 2010. The memory 2020 may be a volatile memory or a non-volatile memory, or may comprise both the volatile memory and the non-volatile memory. The non-volatile memory can be a read-only memory (ROM), a programmable read-only memory (PROM), an erasable programmable read-only memory (EPROM), an electrically erasable programmable read-only memory (EEPROM) or a flash memory. The volatile memory can be a random access memory (RAM), which is used as an external cache. By way of example but not limitation, many forms of RAM are available, such as a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM) and a direct rambus random access memory (DR RAM). It should be noted that the memory of the method described herein is intended to include, but not limited to, these and any other suitable types of memory.

As an example, the image processing device can be implemented as a central processing unit (CPU), which can be used as the computing and control core of the computer system and the final execution unit of information processing and program operation. Alternatively, the image processing device can also be implemented as a graphics processing unit (GPU), which is used as a microprocessor for image and graphics related operations on personal computers, workstations, game consoles and some mobile devices.

As an application scenario, the image processing method provided by the present disclosure can be used to implement video image processing to achieve video feature conversion, such as converting a 2K SDR video to a 4K HDR video. The device integrating the image processing method can be called a video processing device, for example, implemented in GPU or CPU in the form of code. FIG. 13 is a schematic block diagram of a video processing device according to the embodiments of the present disclosure. As shown in FIG. 13, the hardware device can receive the input video for image processing of the video, such as expanding the dynamic range, noise reduction, color mapping, improving resolution, and other operations, and is output and displayed through the monitor. In addition, the device can also receive, for example, operation information input by the user, which indicates which image processing operations are used, for example, the user can select whether to perform the inverse tone mapping process, and for another example, the user can select the template used for color mapping, and so on, which is not limited here. Based on the video processing device shown in FIG. 13, flexible video image processing process can be implemented.

The method or computing system according to the embodiments of the present disclosure can also be implemented with the help of the architecture of the computing device 3000 shown in FIG. 14. As shown in FIG. 14, the computing device 3000 can include a bus 3010, one or more CPU 3020, a read-only memory (ROM) 3030, a random access memory (RAM) 3040, a communication port 3050 connected to the network, an input/output component 3060, a hard disk 3070, etc. The storage device in the computing device 3000, such as ROM 3030 or hard disk 3070, can store various data or files used for processing and/or communication of the image processing method provided by the present disclosure and program instructions executed by the CPU. The computing device 3000 may also include a user interface 3080. Of course, the architecture shown in FIG. 14 is only exemplary. When implementing different devices, one or more components in the computing device shown in FIG. 14 can be omitted according to actual needs.

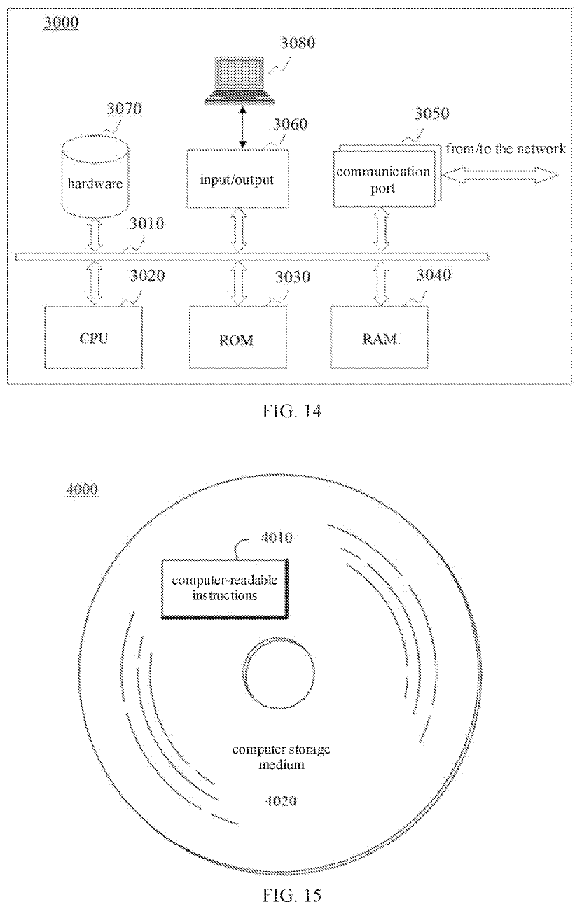

According to another aspect of the present disclosure, a computer-readable storage medium is also provided. FIG. 15 is a schematic diagram 4000 of a storage medium according to the present disclosure.

As shown in FIG. 15, computer-readable instructions 4010 are stored on the computer storage medium 4020. The computer-readable instructions 4010, when executed by a processor, may cause the processor to execute the image processing method described with reference to the above drawings. The computer-readable storage medium includes but is not limited to, for example, volatile memory and/or non-volatile memory. The volatile memory may include, for example, random access memory (RAM) and/or cache memory (cache), etc. The non-volatile memory may include, for example, read-only memory (ROM), hard disk, flash memory, etc. For example, the computer storage medium 4020 can be connected to a computing device such as a computer. Then, when the computing device executes the computer-readable instructions 4010 stored on the computer storage medium 4020, the image processing method provided by the embodiments of the present disclosure described above can be performed.

Those skilled in the art can understand that the contents disclosed in the present disclosure can have many variations and improvements. For example, the various devices or components described above can be implemented by hardware, software, firmware, or implemented in combination with some or all of the three.

In addition, although the present disclosure makes various references to some units in the system according to the embodiments of the present disclosure, any number of different units can be used and run on clients and/or servers. The units are only illustrative, and different aspects of the system and method can use different units.

Those skilled in the art can understand that all or part of the steps in the above method can be completed by instructing the relevant hardware through a program, and the program can be stored in the computer-readable storage medium, such as read-only memory, magnetic disk or optical disk, etc. Alternatively, all or part of the steps of the above embodiments can also be implemented by using one or more integrated circuits. Accordingly, each module/unit in the above embodiment can be implemented in the form of hardware or software function modules. The present disclosure is not limited to any combination of specific forms of hardware and software.

Unless otherwise defined, all terms (including technical and scientific terms) used herein have the same meaning as those commonly understood by those skilled in the art to which this disclosure belongs. It should also be understood that the terms such as those defined in the general dictionary should be interpreted as having the meaning consistent with their meaning in the context of the relevant technology, and should not be interpreted in the sense of idealization or extreme formalization, unless explicitly defined here.

The above are only specific embodiments of the present disclosure and should not be considered as a limited thereof. Although several exemplary embodiments of the present disclosure have been described, those skilled in the art will easily understand that many modifications can be made to the exemplary embodiments without departing from the novel teaching and advantages of the present disclosure. Therefore, all these modifications are intended to be contained in the scope of the disclosure defined by the claims. It should be understood that the above is a description of the present disclosure, and should not be considered as limited to the specific embodiments disclosed, and the modification intention of the disclosed embodiments and other embodiments is included in the scope of the appended claims. The present disclosure is limited by the claims and their equivalents.

1. An image processing method, comprising:
using an inverse tone mapping neural network to process a first image, wherein the inverse tone mapping neural network is configured to expand a dynamic range of the first image and a color gamut range of the first image to obtain a second image that is expanded,
the inverse tone mapping neural network comprises a mapping network, the mapping network is used to realize the expansion, and the inverse tone mapping neural network further comprises an attention network, an input of the mapping network and an input of the attention network are both the first image, the attention network is used to process image contents of the first image to generate correction coefficients, and the correction coefficients are used to correct parameters of the mapping network.

2. The method according to claim 1, wherein the mapping network comprises a first convolution network, a self-residual network and a second convolution network, the mapping network being used to realize the expansion, comprises:
using the first convolution network to process the first image, to obtain a first feature map;
using the self-residual network to process the first feature map, to obtain a second feature map; and
using the second convolution network to process the second feature map, to obtain a third feature map, wherein the third feature map is used as the second image,
the correction coefficients are used to correct parameters of the self-residual network.

3. The method according to claim 1, wherein the self-residual network comprises m self-residual sub-networks that are connected in sequence, m is an integer greater than 1, using the self-residual network to process the first feature map, comprises:
using a first processing path and a second processing path of a first self-residual sub-network in the self-residual network to separately process the first feature map that is received to obtain a first residual feature map;
using a first processing path and a second processing path of an i-th self-residual sub-network in the self-residual network to separately process an (i−1)-th residual feature map that is obtained by an (i−1)-th self-residual sub-network to obtain an i-th residual feature map, wherein i is an integer greater than 1 and less than or equal to m, the first processing path comprises a residual convolution layer, and the second processing path is used to skip processing of the residual convolution layer.

4. The method according to claim 1, wherein a number of feature layers of each residual feature map is n, n is a positive integer, and the attention network processes the image contents of the first image to obtain a coefficient feature map with a number of feature layers of n×m, the coefficient feature map is taken as the correction coefficients and is used to multiply with the residual feature map to correct parameters of the self-residual network.

5. The method according to claim 1, wherein the first convolution network comprises a first convolution layer and an activation function, and the second convolution network comprises a second convolution layer.

6. The method according to claim 1, wherein the first image is an image with a standard dynamic range, and the second image is an image with a high dynamic range.

7. The method according to claim 1, further comprising:
inputting the second image into an enhancement processing network for processing to obtain an enhanced second image, wherein the enhancement processing network comprises a noise reduction network and/or a color mapping network.

8. The method according to claim 1, wherein the first image is a k-th frame of image in a video, and the second image is represented as an expanded k-th frame of image, k is an integer greater than 1, and the method further comprises:
using the inverse tone mapping neural network to process a (k−1)-th frame of image and a (k+1)-th frame of image in the video, respectively, to obtain an expanded (k−1)-th frame of image and an expanded (k+1)-th frame of image; and
using a super-resolution network to process the expanded k-th frame of image, the expanded (k−1)-th frame of image and the expanded (k+1)-th frame of image, to obtain a super-resolution k-th frame of image, wherein a resolution of the super-resolution k-th frame of image is higher than a resolution of the first image.

9. The method according to claim 1, further comprising:
using the super-resolution network to process a k-th frame of image, a (k−1)-th frame of image and a (k+1)-th frame of image in the video to obtain a super-resolution k-th frame of image, the super-resolution k-th frame of image is taken as the first image, wherein a resolution of the first image is higher than a resolution of the k-th frame of image, k is an integer greater than 1.

10. The method according to claim 1, wherein
the inverse tone mapping neural network is trained by using a content loss function.

11. A computing system for image processing, comprising:
one or more processors; and
one or more non-transitory computer-readable medium for storing instructions, wherein the instructions, when executed by the one or more processors, cause the one or more processors to perform operations, and the operations comprise:
using an inverse tone mapping neural network to process a first image, wherein the inverse tone mapping neural network is configured to expand a dynamic range of the first image and a color gamut range of the first image to obtain a second image that is expanded,
the inverse tone mapping neural network comprises a mapping network, the mapping network is used to realize the expansion, and the inverse tone mapping neural network further comprises an attention network, an input of the mapping network and an input of the attention network are both the first image, the attention network is used to process image contents of the first image to generate correction coefficients, and the correction coefficients are used to correct parameters of the mapping network.

12. The computing system according to claim 11, wherein the mapping network comprises a first convolution network, a self-residual network and a second convolution network, the mapping network being used to realize the expansion, comprises:
using the first convolution network to process the first image, to obtain a first feature map;
using the self-residual network to process the first feature map, to obtain a second feature map; and
using the second convolution network to process the second feature map, to obtain a third feature map, wherein the third feature map is used as the second image,
the correction coefficients are used to correct parameters of the self-residual network.

13. The computing system according to claim 11, wherein the self-residual network comprises m self-residual sub-networks that are connected in sequence, m is an integer greater than 1, using the self-residual network to process the first feature map, comprises:
using a first processing path and a second processing path of a first self-residual sub-network in the self-residual network to separately process the first feature map that is received to obtain a first residual feature map;
using a first processing path and a second processing path of an i-th self-residual sub-network in the self-residual network to separately process an (i−1)-th residual feature map that is obtained by an (i−1)-th self-residual sub-network to obtain an i-th residual feature map, wherein i is an integer greater than 1 and less than or equal to m, the first processing path comprises a residual convolution layer, and the second processing path is used to skip processing of the residual convolution layer.

14. The computing system according to claim 11, wherein a number of feature layers of each residual feature map is n, n is a positive integer, and the attention network processes the image contents of the first image to obtain a coefficient feature map with a number of feature layers of n×m, the coefficient feature map is taken as the correction coefficients and is used to multiply with the residual feature map to correct parameters of the self-residual network.

15. The computing system according to claim 11, wherein the operations further comprise:
inputting the second image into an enhancement processing network for processing to obtain an enhanced second image, wherein the enhancement processing network comprises a noise reduction network and/or a color mapping network.

16. The computing system according to claim 11, wherein the first image is a k-th frame of image in a video, and the second image is represented as an expanded k-th frame of image, k is an integer greater than 1, and the operations further comprise:
using the inverse tone mapping neural network to process a (k−1)-th frame of image and a (k+1)-th frame of image in the video, respectively, to obtain an expanded (k−1)-th frame of image and an expanded (k+1)-th frame of image; and
using a super-resolution network to process the expanded k-th frame of image, the expanded (k−1)-th frame of image and the expanded (k+1)-th frame of image, to obtain a super-resolution k-th frame of image, wherein a resolution of the super-resolution k-th frame of image is higher than a resolution of the first image.

17. The computing system according to claim 11, wherein the operations further comprise:
using the super-resolution network to process a k-th frame of image, a (k−1)-th frame of image and a (k+1)-th frame of image in the video to obtain a super-resolution k-th frame of image, the super-resolution k-th frame of image is taken as the first image, wherein a resolution of the first image is higher than a resolution of the k-th frame of image, k is an integer greater than 1.

18. The computing system according to claim 11, wherein
the inverse tone mapping neural network is trained by using a content loss function,
the first image is an image with a standard dynamic range, and the second image is an image with a high dynamic range.

19. An image processing device, comprising:
a processor; and
a memory, wherein the memory stores computer-readable instructions, and the computer-readable instructions, when executed by the processor, perform:
using an inverse tone mapping neural network to process a first image, wherein the inverse tone mapping neural network is configured to expand a dynamic range of the first image and a color gamut range of the first image to obtain a second image that is expanded,
the inverse tone mapping neural network comprises a mapping network, the mapping network is used to realize the expansion, and the inverse tone mapping neural network further comprises an attention network, an input of the mapping network and an input of the attention network are both the first image, the attention network is used to process image contents of the first image to generate correction coefficients, and the correction coefficients are used to correct parameters of the mapping network.

20. A non-transitory computer-readable storage medium, on which instructions are stored, wherein the instructions, when executed by a processor, cause the processor to execute the image processing method according to claim 1.
